(19) United States
(12) Patent Application Publication
(10) Pub. No.: US 2013/0213328 A1
(43) Pub. Date: Aug. 22, 2013

(54) CONTROL VALVE FOR CONTROLLING COMPRESSION RATIO AND COMBUSTION RATE

(71) Applicant: Russell P. Zukouski, Bolingbrook, IL (US)

(72) Inventor: Russell P. Zukouski, Bolingbrook, IL (US)

(73) Assignee: International Engine Intellectual Property Company LLC, Lisle, IL (US)

(21) Appl. No.: 13/882,939

(22) PCT Filed: Nov. 1, 2010
(86) PCT No.: PCT/US10/54987

§ 371 Date: May 1, 2013

(51) Int. Cl. F02D 13/02; F01L 1/46; F01L 1/34

(52) U.S. Cl. CPC F02D 13/0215; F01L 1/34; F01L 1/46
USPC 123/90.15; 123/305

(57) ABSTRACT

A method of controlling the compression ratio in an engine (10) having at least one cylinder (12) with a piston (14) includes providing an air control valve (16) in fluid communication with the cylinder, where the air control valve is in fluid communication with a reservoir (52). The method also includes opening the air control valve (16) in a compression stroke before the piston (14) reaches top dead center, and closing the air control valve (16) when the piston reaches top dead center.

### BACKGROUND

Embodiments described herein relate to internal combustion engines, and more particularly, to addressing emissions from internal combustion engines.

In diesel engines, a stroke is the distance a piston in a cylinder travels from top dead center to bottom dead center. In an intake stroke, an inlet valve opens and the piston travels down from top dead center. When the piston reaches bottom dead center, the cylinder is full of air and the inlet valve closes. With the exhaust valve closed, the piston travels up from bottom dead center in a compression stroke. Typically, before the piston reaches top dead center, liquid fuel is injected into the engine cylinders that contain compressed air at a high temperature, however fuel injection can also occur after the piston reaches top dead center. The liquid fuel evaporates and mixes with the compressed air to form a flammable mixture that ignites. Combustion occurs, and the expanding gases force the piston down to bottom dead center in a power stroke. The exhaust valve opens, and the piston moves up to top dead center during the exhaust stroke, and the cycle begins again at the intake stroke.

The amount of exhaust emissions generated by the diesel engine, such as carbon monoxide and particulate matter, is generally related to the ending time of the fuel injection during each piston cycle. Typically, the earlier the fuel injection duration ending time, the less carbon monoxide and particulate matter that are generated in the combustion cycle. However, early fuel injection increases engine cycle temperature, which results in relatively higher amounts of nitrogen oxides NOx exhausted from the diesel engine.

To reduce NOx emissions, fuel injection timing may be retarded relative to conventional fuel injection timing, which results in a later fuel injection duration ending time. However, the later fuel injection duration ending time may cause incomplete and untimely combustion in the cylinders, and may increase generation of carbon monoxide and particulate matter.

### SUMMARY

A method of controlling the compression ratio in an engine having at least one cylinder with a piston includes providing an air control valve in fluid communication with the cylinder, where the air control valve is in fluid communication with a reservoir. The method also includes opening the air control valve in a compression stroke before the piston reaches top dead center, and closing the air control valve when the piston reaches top dead center.

Another method of controlling the compression ratio in an engine having at least one cylinder with a piston includes providing an air control valve in fluid communication with the cylinder, where the air control valve is in fluid communication with a reservoir. The method also includes opening the air control valve in a compression stroke before the piston reaches top dead center, and closing the air control valve in the compression stroke after the air control valve is opened and before the piston reaches top dead center.

An air control valve system for an engine having at least one cylinder with a piston includes a reservoir in fluid communication with the cylinder. The system also includes a control valve associated with the cylinder for selectively permitting the flow of air from the cylinder to the reservoir during a compression stroke. The control valve also selectively permits the flow of air from the reservoir to the cylinder before a combustion stroke. A controller opens and closes the control valve.

### BRIEF DESCRIPTION OF THE DRAWINGS

FIG. 1 is a schematic of air control valve disposed on engine cylinders, wherein the engine cylinders are in fluid communication with an air reservoir.

FIG. 2 is a cross-section of the air control valve.

FIG. 3 is a timeline showing the actuation of the air control valve with respect to the position of the piston.

### DETAILED DESCRIPTION

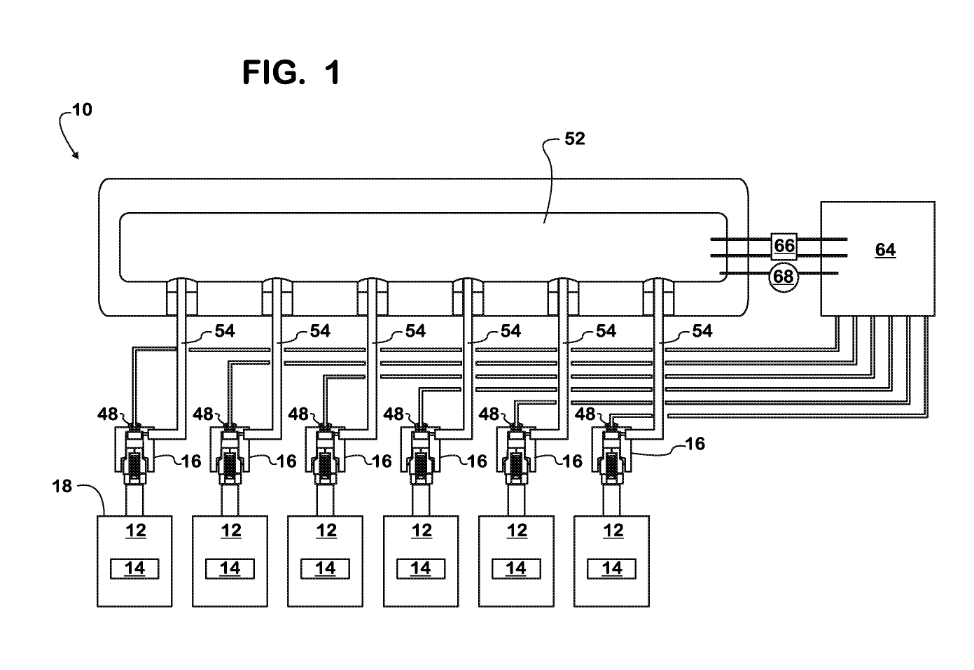

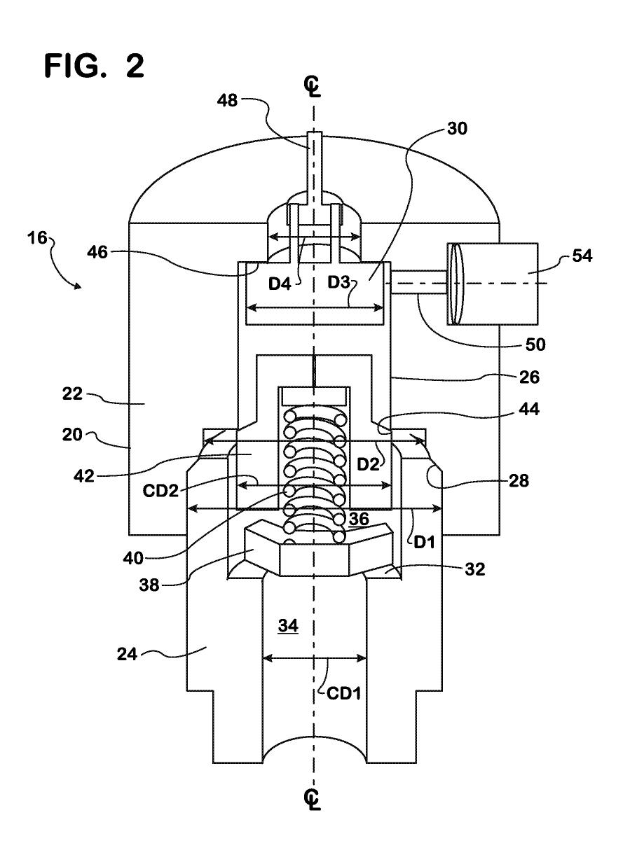

Referring to FIGS. 1-2, an engine is depicted schematically at 10 and includes a plurality of cylinders 12 having an inline, V-arrangement, or any other arrangement of plural cylinders. The engine 10 may be any internal combustion engine, including but not limited to a diesel engine, a gasoline engine, and a homogeneous charge compression ignition engine. A piston 14 is disposed in each cylinder 12 and cycles from a top dead center (TDC) to a bottom dead center (BDC) and back to TDC, as is known in the art.

Each cylinder 12 has an air control valve 16 disposed generally at an upper end 18 of the cylinder. One embodiment of the air control valve 16 is shown in the drawings and will be described in detail herein, however it is to be considered an exemplification of the air valve and is not intended to be limited to the specific embodiment illustrated. Further, it should be appreciated that the air control valve 16 is separate from the intake valve of the engine 10.

In the air control valve 16, a housing 20 may be disposed generally at the upper end of the cylinder 12 or cylinder head. A first housing portion 22 may receive a second housing portion 24, or alternately, may receive the upper end of the cylinder 12. The first housing portion 22 may be generally cylindrical and circumscribe the second housing portion 24, however other configurations are possible. The second housing portion may also be generally cylindrical and provide fluid communication from the cylinder 12 to the first housing portion 22.

At least a portion of the second housing portion 24 may be sealingly received in an interior receiving space 26 of the first housing portion 22. The interior receiving space 26 is a fluid pathway and may have a first diameter D1 that receives the second housing portion 24, or alternately the cylinder 12, a second diameter D2 smaller than the first diameter D1 that forms a stop 28 and prevents the second housing portion 24 from occupying the interior receiving space 26 at the second diameter D2, a third diameter D3 that is smaller than the second diameter D2, and a fourth diameter D4 that is smaller than the third diameter D3.

A plunger 30 may be seated on a generally annular seat 32 in the second housing portion 24, however the seat may have other shapes. Below the seat 32, the second housing portion 24 may have a first chamber 34 having a first diameter CD1, and above the seat, the second housing portion 24 may have a second chamber 36 having a second diameter CD2 that is larger than the first diameter. A base 38 of the plunger 30 may engage the seat 32 from above the seat in the second chamber 36, and permits the fluid communication from the first chamber 34 to the second chamber at the seat.

Extending from the base 38 and generally circumscribing a centerline CL is a spring 40. A plunger body 42 may be generally concentrically disposed about the spring 40, which biases the plunger body away from the base 38 and against a second stop 44 formed in the interior receiving space 26 between the second and third diameters D2, D3. In the biased position shown in FIG. 2, the air control valve 16 is closed.

The plunger body 42 is sized and shaped to permit the fluid communication from the second chamber CD2 to the interior receiving space 26 of the housing 20 at the second diameter D2, however the plunger body 42 is sized and shaped to prevent the fluid communication from the second diameter D2 to the third diameter D3 at the second stop 44. The plunger body 42 may be generally cylindrical in shape, however other shapes are contemplated.

In the biased position of FIG. 2, the plunger body 42 extends into the interior receiving space 26 at the third diameter D3 where it engages a third stop 46 formed in the interior receiving space 26 between the third and fourth diameters D3, D4. An actuator 48 is reciprocally disposed in the interior receiving space 26 at the fourth diameter D4 and is generally disposed concentrically about the centerline CL.

At the interior receiving space 26 at the third diameter D3, an air channel 50 is in fluid communication with the interior receiving space and may be defined by a channel defined by the housing 20. The air channel 50 may be oriented generally perpendicular to the centerline CL, however other orientations are possible. The air channel 50 is in fluid communication with an air reservoir 52. A hose 54 may be received in the air channel 50 to communicate the air to and from the interior receiving space 26 to the air reservoir 52.

The plunger 30 displaces along the centerline CL of the air control valve 16 on the spring 40. When the actuator 48 is actuated, the actuator overcomes the spring bias and displaces the plunger 30 down towards the cylinder 12, which compresses the spring 40, and unseats the plunger body 42 from the second stop 44. Unseating of the plunger body 42 from the second stop 44 permits the fluid communication from the first chamber CD1, to the second chamber CD2, to the interior receiving space 26 at the second diameter D2, to the interior receiving space 26 at the third diameter D3, to the air channel 50, and to the air reservoir 52.

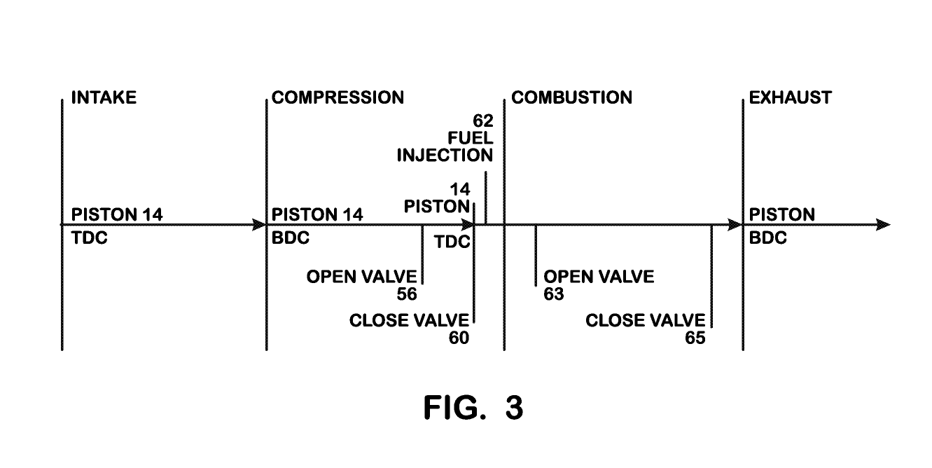

Referring now to FIGS. 1 and 3, each air control valve 16 is in fluid communication with each corresponding cylinder 12. The air control valves 16 are opened at step 56 at some point just prior to the piston 14 reaching TDC 58, such that the movement of the piston to TDC displaces high pressure air from the cylinder 12 into the high pressure reservoir 52. For example, control valves 16 may open when the crank angle is about −70 to +5 prior to the injection event, and may remain open until about 0 to +180 prior to BDC. Alternatively, a first control valve 16 may open when the crank angle is about −70 to +5 prior to the injection event, and a second valve 16 may open at or about 0 to +180 prior to BDC. The timing of the opening of the air control valve 16 may be coordinated with variable compression ratio desirability. By controlling the amount of bleeding off of the final portion of compressed air in the cylinder through the air control valve 16, there is controlled variability of the compression ratio.

Each of the air control valves 16 are then closed at TDC 56, or closer to TDC, at step 60 to prevent premature flow of the high pressure air from the reservoir 52 back into the cylinders 12. The air control valves 16 are closed prior to fuel injection at step 62, and the air control valves remain closed during the initial combustion. After combustion is initiated, the air control valves 16 are opened again at step 63 to allow the air from the high pressure reservoir 52 into the cylinder 12, which provides oxygen and mixing energy relatively late in the combustion event, which reduces soot generation and improves the oxidation rate of soot. The flow of air from the reservoir 52 during the combustion stroke re-activates the combustion process. The air control valves 16 can be closed again 65 at any point prior to the exhaust stroke. The control valves 16 can also be selectively opened to permit the flow of air from the reservoir 52 to the cylinder during the expansion and exhaust strokes for emulating exhaust gasses/scavenging of the cylinder.

While the air control valve 16 and method of controlling the compression ratio is applicable to engines 10 that inject fuel after the piston 14 reaches TDC, it can also be used with homogeneous charge compression ignition (HCCI) engines. In HCCI engines, the fuel and air are compressed to the point of auto-ignition, which means that there is no well-defined combustion initiator that can be directly controlled. Engines can be designed so that the auto-ignition conditions occur at a desirable timing, such as by controlling the compression ratio with the air control valve 16.

The actuator 48 of the air control valve 16 may be selectively and electronically controlled by a control unit 64, such as an engine control unit (ECU), which may take into account several factors, including speed and load of the engine 10, the pressure in the reservoir 52, among other factors. An oxygen sensor 66 may be used for determining the amount of oxygen in the reservoir 52, and a pressure sensor 68 may be used for determining the pressure of the air in the reservoir 52. The oxygen level and the pressure may be used to determine the amount of air introduced from the reservoir 52 to the cylinder 12, or the opening time of the air control valves 16 during the combustion event. Further, while the air control valve 16 and the reservoir 52 may regulate air, it is possible that other fluids can be used.

The air control valve 16 may provide variable compression ratio in the engine 10 and may also provide a reduction in soot generation. Further, the air control valve 16 may provide control of the ignition point and rate of burn of combustion in the engine 10.

What is claimed is:

1) A method of controlling compression ratio in an engine having at least one cylinder with a piston; the method comprising:
providing an air control valve in fluid communication with the at least one cylinder, wherein the air control valve is in fluid communication with a reservoir;
opening the air control valve in a compression stroke before the piston reaches top dead center; and
closing the air control valve when the piston reaches top dead center.

2) The method of claim 1 further comprising the step of opening the air control valve during the combustion stroke after combustion is initiated.

3) The method of claim 1 further comprising the step of biasing the air control valve to a closed position.

4) The method of claim 1 further comprising the step of storing air in the reservoir after the air control valve is opened.

5) The method of claim 2 further comprising the step of communicating the air from the reservoir to the at least one cylinder after the air control valve is opened during the combustion stroke.

6) The method of claim 2 further comprising the step of closing the air control valve before the exhaust stroke.

7) The method of claim 1 further comprising the step of injecting fuel into the at least one cylinder in a compression stroke after the piston reaches top dead center.

8) A method of controlling compression ratio in an engine having at least one cylinder with a piston; the method comprising:
providing an air control valve in fluid communication with the at least one cylinder, wherein the air control valve is in fluid communication with a reservoir;
opening the air control valve in a compression stroke before the piston reaches top dead center; and
closing the air control valve in the compression stroke after the air control valve is opened and before the piston reaches top dead center.

9) The method of claim 8 further comprising the step of opening the air control valve during the combustion stroke after combustion is initiated.

10) The method of claim 8 further comprising the step of biasing the air control valve to a closed position.

11) The method of claim 8 further comprising the step of storing air in the reservoir after the air control valve is opened.

12) The method of claim 9 further comprising the step of communicating the air from the reservoir to the at least one cylinder after the air control valve is opened during the combustion stroke.

13) The method of claim 9 further comprising the step of closing the air control valve before the exhaust stroke.

14) The method of claim 8 further comprising the step of injecting fuel into the at least one cylinder in a compression stroke after the piston reaches top dead center.

15) The method of claim 8 further comprising the step of sensing the oxygen level in the reservoir.

16) The method of claim 8 further comprising the step of sensing the pressure in the reservoir.

17) The method of claim 8 further comprising the step of opening and closing the air control valve with an engine control unit.

18) An air control valve system for an engine having at least one cylinder with a piston, the air control valve system comprising:
a reservoir in fluid communication with the at least one cylinder;
a control valve associated with the at least one cylinder for selectively permitting the flow of air from the at least one cylinder to the reservoir during a compression stroke, and from the reservoir to the at least cylinder before a combustion stroke; and
a controller for opening and closing the control valve.

19) The air control system of claim 18 wherein the control valve further comprises:
a housing having an interior receiving space forming a fluid pathway from the at least one cylinder to the reservoir;
a plunger disposed in the interior receiving space, the plunger having a spring that biases the plunger against a stop to prevent the flow of air between the cylinder and the reservoir; and
an actuator configured to overcome the spring bias and displace the plunger away from the stop to permit the flow of air between the cylinder and the reservoir.

20) The air control system of claim 19 further comprising an air channel disposed in the housing for communicating air between the interior receiving space and the reservoir.
